(19) United States
(12) Patent Application Publication
(10) Pub. No.: US 2005/0195079 A1
(43) Pub. Date: Sep. 8, 2005

(54) Emergency situation detector

(76) Inventor: David Cohen, Tel Aviv (IL)

Correspondence Address: Martin Moynihan;c/o ANTHONY CASTORINA, SUITE 207, 2001 JEFFERSON DAVIS HIGHWAY, ARLINGTON, VA, 22202, US

(21) Appl. No.: 10/902,874

(22) Filed: Aug. 2, 2004

(30) Foreign Application Priority Data
Mar. 8, 2004 (IL) 160783

(51) Int. Cl. G08B 1/08

(52) U.S. Cl. 340/539.12; 340/573.1; 600/300; 340/539.13

(57) ABSTRACT

Emergency situation detection apparatus comprising: a stress input unit for receiving body stress information from a subject, a physical input unit for receiving body physical reaction data from said subject, a comparator unit, associated with said stress input unit and said physical input unit, for comparing stress level information and physical reaction data, to detect substantially simultaneous stress level change and a physical reaction in said subject, said apparatus being operable to threshold said simultaneous detection to infer the presence of an emergency situation and to enter an alarm state.

### RELATIONSHIP TO EXISTING APPLICATION

The present application is a continuation in part of PCT Patent Application No. PCT/IL2004/000288, filed on 29 Mar. 2004, which claims priority from Israel Patent Application No. 160783, filed on 8 Mar. 2004, the contents of which are hereby incorporated by reference in their entirety.

### FIELD OF THE INVENTION

The present invention relates to an emergency situation detector and a method of use and also to relay system therefor.

### BACKGROUND OF THE INVENTION

In many typical security situations, the line of defense and many times the only line of defense at a secured area is a human attendant hereafter referred to as the guard.

Whether 9/11 type air crew assault events, or a security guard assault at a nuclear plant, or a cashier in a store, once the aggressor surprises the guard he is often free to inflict damage without disturbance.

The above described system in which the main line of defense at a secured area is the guard has certain weaknesses as follows:

The system is subject to the guard's reliability or lack thereof, his folly, and any professional misconduct.

The system is subject to the guard's ability to actively sound the alarm and call for help before an aggressor is able to neutralize him.

The system is subject to the guard's ability, following a hazardous event, to report reliably and coherently to HQ fully unveiling events taking place, while trying to repulse an aggressor.

The system is vulnerable to a decision makers ability, particularly at the initial stages of a hazardous event, to take critical decisions, often in virtual tactical blindness.

The above-mentioned security flaws are all well known to criminals/terrorists and as such present major unresolved security problems on a global scale.

It is desirable to know when personnel encounter emergency siphons or to keep watch on personnel in sensitive or dangerous situations. In particular security personnel including night watchman and guards, airline pilots, truck and van drivers and the like can be the subject of attacks and other emergencies with which they are unable to cope. In such a case it is desirable for the subject of the attack to call for help, but sometimes the name of the emergency renders calling for help impossible.

Beyond the security field altogether, elderly and other vulnerable persons, particularly those living on their own, can find themselves in difficulties and unable to reach a telephone to call for help, for example after a fall.

In cases where it is not possible to call for help, a number of systems exist for automatically deter that an emergency situation exists and calling for help.

Hospital-based systems that monitor a patient's pulse and call a doctor or nurse if the pulse falls are well known but are not suitable for anything other than the hospital environment.

Aircraft based hijack warning systems rely upon the pilot's standard radio-based voice link to air traffic control or include panic buttons for broadcasting an SOS signal. Hijackers however tend to be familiar with the presence of these systems and either use dim to their advantage or prevent their use altogether.

Other systems for protecting aircraft from emergencies tend to rely on pilots' reaction times. Certain types of emergencies happen too quickly for the pilots to be able to raise the alarm or divert the pilots to emergency activity without diverting their attention to raising the alarm.

Often, the ability to determine what has happened following an aviation disaster is dependent on finding the aircraft flight recorder or black box.

Israel Patent Application No. 145498 to the present applicant discloses a system for detecting cockpit emergencies comprising the following:
a) an input unit for receiving body stress level information from at least two subjects,
b) a detection unit, associated with said input unit, for comparing stress level information from said at least two subjects, to detect substantially simultaneous stress level increases in said subjects, the system being operable to threshold detected simultaneous stress level increases to infer the presence of an emergency situation and to enter an alarm state.

The system uses the physiological state of the pilots to determine that an emergency situation has arisen. In order to reduce false alarms it takes data from the two pilots and deduces the presence of an alarm when both pilots indicate stress. Such a system has the disadvantage that it is only useful in situations such as the cockpit of a civil aircraft where two or more persons are likely to undergo the same emergency. The system is not applicable to security guards, elderly people living alone and the like. Likewise it is not applicable for monitoring of persons being sent into dangerous situations such as troops into battle or firemen into a burning building.

### SUMMARY OF THE INVENTION

According to the present invention there is provided emergency situation detection apparatus comprising:

a stress input unit for receiving body stress information from a subject,

a physical input unit for receiving body physical reaction data from the subject,

a comparator unit, associated with the stress input unit and the physical input unit, for comparing stress level information and physical reaction data, to detect substantially simultaneous stress level change and a physical reaction in the subject,

the apparatus being operable to threshold the simultaneous detection to infer the presence of an emergency situation and to enter an alarm stat.

Preferably, the thresholding is a thresholding of the changes.

The system is configured for attachment to the subject.

The system is configured for attachment to the trunk region of a user, above the hip region.

The system may be configured for attachment to the chest.

The system may be for attachment around the stomach.

The system may be configured for agent on the hips.

Preferably, the stress level information comprises pulse rate information.

Preferably, the stress level information comprises breathing rate information.

Preferably, the stress level information is sweat level information.

The system may comprise a sensor for detecting ECG information.

The system may be configured to interpret extremely low stress level information as the subject being in a state of sleep.

Preferably, the physical input unit comprises an inclination detector affixed to the subject

Preferably, the physical input unit comprises an accelerometer.

Preferably, the physical input unit is connected to detection logic to identify physical behavior patterns.

Preferably, the patterns comprise complexes of impact and sway behavior events.

Preferably, the input unit is responsive to transmitter units placed on the subject.

Preferably, the alarm stale comprises automatic opening of a communication channel to a central controller.

The system may be configured to use the communication channel for ongoing transmission during the course of an identified emergency situation.

Preferably, the alarm state comprises automatic opening of an audio chapel to a central controller.

Preferably, an end of the audio channel is located on the subject.

Preferably, the alarm state comprises automatic opening of a video link to a central controller.

Preferably, the alarm state is additionally triggerable by at least one of an instability monitor, and a loud sound monitor.

Preferably, the device is sized and configured for mounting unobtrusively on a subject

The apparatus may comprise location detection functionality for determining a location, the apparatus further being configured to report the location

Preferably, the location detection functionality is one of a group comprising a GPS detector and a triangulation system.

Preferably, there is provided a direction sensor, the direction sensor comprising a compass needle and functionality for measuring an angle of the compass needle in relation to a reference.

The device may be associated with a memory stick for storing a predetermined amount of immediately preceding data, the detector being configured to save all data in the stack upon entry into the alarm slate.

The system may comprise a short range communicator for communicating with a relay device.

Preferably, the relay device is connected to a telephone socket

The system may comprise a first relay associated with a user and a second relay associated with a telephone socket.

Preferably, the relay device is a cellular relay device.

The system may comprise a first relay associated with a user and a second relay being a cellular relay device.

Preferably, the relay device is a satellite telephony device.

The system may comprise a first relay associated with a user and a second relay being a satellite telephony device.

Preferably, the relay device is an r.f. relay.

The system may comprise a first relay associated with a user and a second relay being an R.F. relay.

Preferably, the short range communicator is configured to use a wireless local network protocol.

The detector may be adapted for use in a vehicle by fixing a second physical detector to the vehicle and obtaining a difference signal between the physical detectors for feeding to the comparator.

Preferably, the vehicle is any one of a group comprising a land vehicle, a road vehicle, an off-road vehicle, a railway vehicle, a ship and an aircraft

The system may be adapted for use in the vehicle by including a relay attached to the vehicle to relay signals from the user via the vehicle to the remote location.

According to a second aspect of the present invention there is provided an emergency situation detection method comprising:

receiving body stress level information from a subject,

receiving body physical reaction data from the subject, comparing stress level information and physical reaction data, to detect substantially simultaneous stress level change and physical reaction in the subject, and thresholding the simultaneous detection to infer the presence of an emergency situation and to enter an alarm state,

Preferably, the thresholding comprises thresholding of rates of change.

Preferably, the stress level information comprises pulse rate information.

Preferably, the stress level information is breathing information.

Preferably, the stress level information is sweat level information.

Preferably, the physical reaction data is body angular inclination data.

Preferably, the physical reaction data is body acceleration data.

The method may be responsive to transmitter units placed on the subject.

Preferably, the alarm state comprises automatic openings of a radio link to a central controller.

Preferably, the alarm state comprises automatic opening of a video link to a central controller.

The method may comprise carrying out short range communication for communicating to a central controller via a relay device.

According to a third aspect of the preset invention there is provided a system comprising rule based logic and at least one body sensor for location on a subject, the subject being expected to follow certain behavioral rules, the at least one sensor being usable in combination with the rule based logic to detect non-compliance with the behavioral rules, thereby to indicate an abnormal situation.

Preferably, the logic unit is configured to provide two level logic, a first level defining a plurality of events for giving rise to an alarm state, and a second level defining at least one combination of the events in the first level to provide at least one alarm state.

Preferably, the events comprise at least one of a group comprising:

a change in linear acceleration of at least a predetermined level within a predetermined time;

a change in angular acceleration of at least a predetermined level within a predetermined time,

an impact of greater than a told level;

an acoustic sound of a predetermined spectrum,

a voiced sound of a predetermined set with a predetermined voiceprint; a body attitude of a predetermined angle or greater held for a predetermined amount of time;

a left body attitude of a predetermined angle or greater held for a predetermined amount of time and a right body attitude of a predetermined angle or greater held for a predetermined amount of time and a forward body attitude of a predetermined angle or greater held for a predetermined amount of time and a backward body attitude of a predetermined angle or greater held for a predetermined amount of time;

a user being outside of a given area for a predetermined amount of time;

a user being or not being at a given location at a predetermined time;

a heartrate outside predetermined bounds for a predetermined amount of time;

sway of a predetermined pattern; and

a user taking longer than a predetermined time to reach a given location.

The system may be configured to measure a predetermine event using at least two sampling rates in order to obtain different kinds of information therefrom.

The system may comprise at least a second body sensor usable in combination with the behavioral rules.

Preferably, the behavioral rules include expected behaviors of a vehicle.

Preferably, the events include the user sleeping or dozing when he is not expected to.

Preferably, the events include the user walking when expected to be stationary or being stationary when expected to be walking.

Preferably, the behavioral rules define expected attitudes of user body positions.

Preferably, the behavioral rules define places where the user is expected to be located and where the user is expected not to be located.

Preferably, the behavioral rules include expected behaviors following major impacts.

Preferably, the behaviors include behavior complexes comprising combinations of behavior events.

The system may be configured to rank the behaviors in an order of severity.

The system may comprise a location detection device and wherein the rule based logic contains rules based on location.

The system may be programmable to allow dynamic changing of the rules.

According to a fourth aspect of the present invention there is provided a direction sensor for mounting on a mobile body, the direction sensor comprising a compass needle and functionality for measuring an angle of the compass needle in relation to a reference, the direction sensor being configured for mounting in orientation fixed manner on the mobile body.

Preferably, the mobile body is a person, the direction sensor being configured for mounting on a part of the person indicative of a direction that the person is facing.

According to a fifth aspect of the present invention there is provided an emergency situation detection apparatus comprising:

a physiological input unit for receiving body physiological information from a subject,

a physical input unit for receiving body physical reaction data from the subject, and

a logic unit, associated with the physiological input unit and the physical input unit, for applying at least one logical operation simultaneously to the physiological information and the physical information, to infer the presence of an emergency situation and to enter an alarm state.

Preferably, the logic unit is configured to provide two level logic, a first level defining a plurality of events for giving rise to an alarm state, and a second level defining at least one combination of the events in the fist level to provide at least one alarm state.

The apparatus may be configured for attachment to the subject.

The apparats may be configured for attachment to the trunk region of a user, above the hip region.

The physiological level information may comprise pulse rate information.

Preferably, the physiological level information comprises breathing rate information.

Preferably, the physiological level information is sweat level information.

Preferably, the physiological information is data indicating whether a user is asleep.

Preferably, the physical input unit comprises an inclination detector affixed to the subject.

Preferably, the physical input unit comprises an accelerometer.

Preferably, the input unit is responsive to transmitter units placed on the subjects.

Preferably, the alarm state comprises automatic opening of a communication channel to a central controller.

Preferably, the alarm state comprises automatic opening of an audio channel to a central controller.

Preferably, an end of the audio channel is located on the subject.

Preferably, the alarm state comprises automatic opening of a video link to a central controller.

Preferably, the alarm state is additionally triggerable by at least one of an instability monitor, and a loud sound monitor.

The apparatus may be sized and configured for mounting unobtrusively on a subject.

The system may comprise location detection functionality for determining a location, the apparatus further being configured to report the location.

Preferably, the location detection functionality is one of a group comprising a GPS detector and a triangulation system.

The system may comprise a direction sensor, the direction sensor comprising a compass needle and functionality for measuring an angle of the compass needle in relation to a reference.

The detector may be associated with a memory stack for storing a predetermined amount of immediately preceding data, the detector being configured to save all data in the stack upon entry into the alarm state.

Preferably, the indication of an alarm state comprises any of an impact, an impact causing a subject to falling down, and an impact causing physiological readings to change.

Preferably, the indication of an alarm state comprises any of an impact, an impact causing a subject to falling down, and an impact causing physiological readings to change.

Preferably, the indication of an alarm state comprises any of an impact, an impact causing a subject to falling down, and an impact causing physiological readings to change.

Preferably, the indication of an alarm state comprises any of an impact, an impact causing a subject to falling down, and an impact causing physiological readings to change.

Preferably, an additional detector is located on a wall of a vehicle carrying a subject, so as to cancel out vibrations of the vehicle.

According to a further aspect of the present invention there is provided a central co-ordination unit for controlling a plurality of remotely located emergency situation detectors, each detector comprising:

a stress input unit for receiving body stress information from a subject,

a physical input unit for receiving body physical reaction data from the subject,

a comparator unit, associated with the stress input unit and the physical input unit, for comparing stress level information and physical reaction data, to detect substantially simultaneous stress level change and a physical reaction in the subject,

the apparatus being operable to threshold the simultaneous detection to infer the presence of an emergency situation and to enter an alarm state,

the co-ordination unit comprising an alarm unit for indicating that one of the detectors has entered an alarm state and a contact unit for contacting and providing a location of one of the detectors having entered the alarm state.

According to a further aspect of the present invention there is provided a vehicle protection unit for emergency situation detection and monitoring of the vehicle, the protection unit comprising:

a sensor associated with the vehicle for sensing vehicle situation data;

a logical unit associated with the sensor for determining from the output of the sensor whether an emergency situation is present; and

an alarm unit for entering an alarm state on detection of the emergency situation, the alarm state comprising setting a transmitter to transmit vehicle situation data to a remote location.

Preferably, the sensor is an inclination sensor for detecting inclination information of the vehicle.

Preferably, the inclination unit is a multi-dimensional inclination unit.

Preferably, the logical unit comprises an expected behavior pattern for the vehicle and is configured to recognize deviations from the expected behavior patterns as indicative of the emergency situation.

Preferably, the sensor comprises an impact sensor for sensing an impact associated with the vehicle.

Preferably, the sensor comprises an audio detector for detecting audio disturbances in association with the vehicle.

Preferably, the sensor comprises a fume detector for detecting fumes in association with the vehicle.

Preferably, the sensor comprises a radiation detector for detecting radiation presence in association with the vehicle.

Preferably, the sensor comprises an accelerometer for detecting acceleration of the vehicle.

Preferably, the vehicle situation data comprises flight recorder data.

The unit may comprise a data buffer for storing previous data for a predetermined amount of time and wherein the vehicle situation data is data currently stored in the buffer.

Preferably, the transmitter is configured to transmit vehicle situation data throughout the emergency situation.

Preferably, the transmitter is configured during the emergency situation to open at least one of an audio and a video channel to allow a remote controller to be in contact with the vehicle.

Preferably, the vehicle is at least one of a group comprising an aircraft, a waterborne vessel, a land vehicle, a road vehicle, an offroad vehicle and a railway train.

Preferably, the logical unit is configured to rank different kinds of emergency situations.

The system may comprise a relatively short range communicator for communicating with a relay device.

The system may comprise a relay for relaying signals from persons on the vehicle to a central controller.

According to a further aspect of the present invention there is provided a system comprising rule based logic and at least one body sensor for location on a subject, the subject being expected to follow certain physical rules, the at least one sensor being usable in combination with the rule based logic to detect noncompliance with the physical rules, thereby to indicate an abnormal situation.

The system may comprise an event pattern comprising a complex of physical events, the event pattern indicating the abnormal situation.

Preferably, the complex comprises a first event being an impact event.

Preferably, the impact is accompanied by a change of inclination angle.

According to a further aspect of the present invention there is provided emergency situation detection apparatus comprising at least one of
a) a stress input unit for receiving body stress information from a subject,
b) a physical input unit for receiving body physical reaction data from the subject, and
c) a voice input unit for recognizing stress-indicating audio input;

a comparator unit, associated with the at least two input units, for comparing stress level information and physical reaction data, to detect substantially simultaneous stress level change and a physical reaction in the subject,

the apparatus being operable to threshold the simultaneous detection to infer the presence of an emergency situation and to enter an alarm state.

The apparatus may comprise at least two of the input units.

The apparatus may comprise a short range transmitter for transmitting to a relay device.

The apparatus may comprise a transmitter for transmitting to a central controller.

The apparatus may be configured for attachment to a person.

The apparatus may further comprise a location detector being one of a group comprising a triangulation device and a GPS device.

According to a further aspect of the present invention there is provided an emergency situation detection apparatus comprising

a voice input unit for recognizing stress-indicating audio input;

a comparator unit, associated with the at least two input units, for comparing stress level information and physical reaction data, to detect substantially simultaneous stress level change and a physical reaction in the subject,

the apparatus being fixable to a location and operable to threshold the simultaneous detection to infer the presence of an emergency situation and to enter an alarm state.

According to a further aspect of the present invention there is provided a relay device for an emergency situation detection apparatus, the relay device comprising a receiver for receiving alarm state data from an emergency situation detection apparatus within range, a data enhancer for enhancing the alarm state data and an output for sending the enhanced data onwards to a remote location.

Preferably, the data enhancer is configured to add location data of the relay device to the alarm state data.

Preferably, the data output is configured for attachment to a telephone socket to work through the PSTN network.

Preferably, the data output comprises a cellular unit to send data via a cellular telephony network.

The relay may be configured for mounting on a vehicle, vessel or aircraft, wherein the location data is obtained from a location sensor.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understating of the invention, the description taken with the drawings making apparent to those skilled in the art how the several forms of the invention may be embodied in practice. In the accompanying drawings,

FIG. 1 is a simplified diagram of an emergency situation detection device according to a first embodiment of the present invention;

FIG. 2 is a simplified block diagram of internal components of the device shown in FIG. 1;

FIG. 3 is a simplified flow chart showing a method of using the device of FIG. 1;

FIG. 4 is a continuation of the flow chart of FIG. 3, showing the procedure within the alarm state;

FIG. 5 is a simplified diagram showing the display on a controller's sceen when a security guard on patrol reports an alarm state.

FIG. 6 is a simplified diagram illustrating a hierarchy of alarm state events, and showing the events being ordered according to severity of the event and secondarily according to the time of occurrence;

FIG. 7 illustrates a controller reacting to an event which appears on one of his screens;

FIGS. 8A to 8C illustrate alternative configurations for a communication system on board an aircraft for overriding the regular communication system to report alarm events; and

FIG. 9 is a tree diagram illustrating different fields to which embodiments of the present invention are applicable.

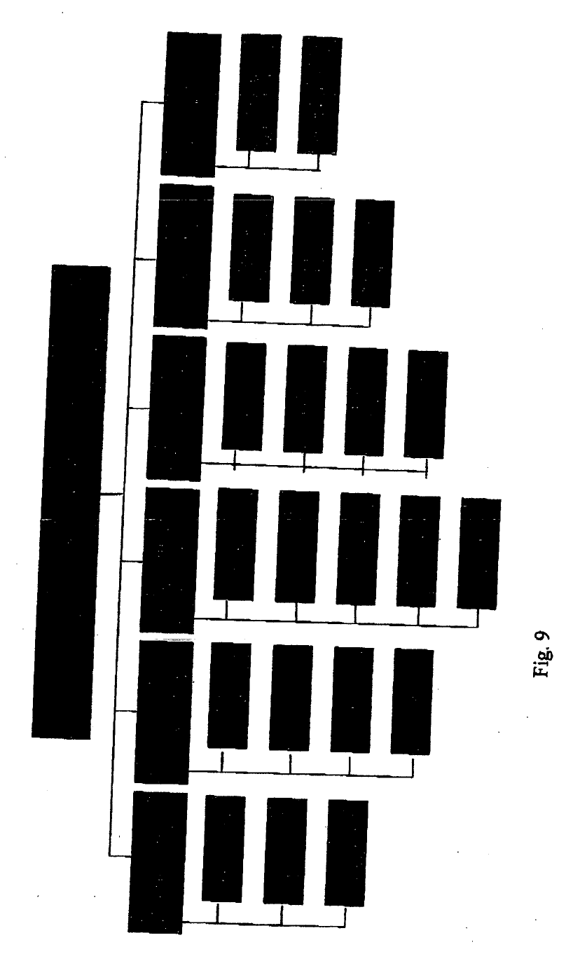

### DESCRIPTION OF THE PREFERRED EMBODIMENTS

The present embodiments provide a personally mounted alarm device capable of indicating automatically & in real-time any breach of the human line of defense, to a remote location. The alarm device is able to establish at least some of the following: that the guard is under physical attack or has been injured and what his current state is, that the guard is being negligent on a professional mission, that the guard is dozing off or has fallen asleep, that the guard is reporting reliably, that the guard is exposed and/or exposing employer to a potentially hazardous situation and other similar information in accordance with the specific circumstances.

The alarm device allows the guard's post factum performance to be monitored. Furthermore one embodiment has a memory buffer which always stores the last minute's data, so that in the event of an emergency, the moments leading up to the emergency can be looked at.

In one preferred feature, the guard's medical condition can be monitored vie EKG & respiratory state evaluation in a post attack mode.

Further embodiments provide an emergency situation detector which uses a first sensor that detects features of the fight or flight physiological response of subjects to determine that an emergency situation exists and to automatically raise an alarm. A supporting signal can then be taken from an independent physical sensor which measures something other than body stress, such as physical body attitude, and forces in general which relate to the external environment, such as an external mechanical impact, a sudden acceleration, a sudden angular change, gases or other substances in the atmosphere and the like. The use of an average, or other combination, of the signals from the stress and the physical detector provides protection against false alarms caused by self-induced anger, pure fright unaccompanied by an attack, and the like to which individual subjects may be susceptible. The signals may be measured against a threshold, or a delta may be used.

In a broader sense the present embodiments provide indication of dangerous situations arising or of circumstances that could lead to dangerous situations. For example, the embodiments may be able to determine, from physiological and/or physical, measurements, that a security guard has fallen asleep or has left his post or has conducted a patrol in a negligent manner or has been attacked and is injured, and therefore is not doing his duty of guarding etc.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and technology employed herein is for the purpose of description and should not be regarded as limiting.

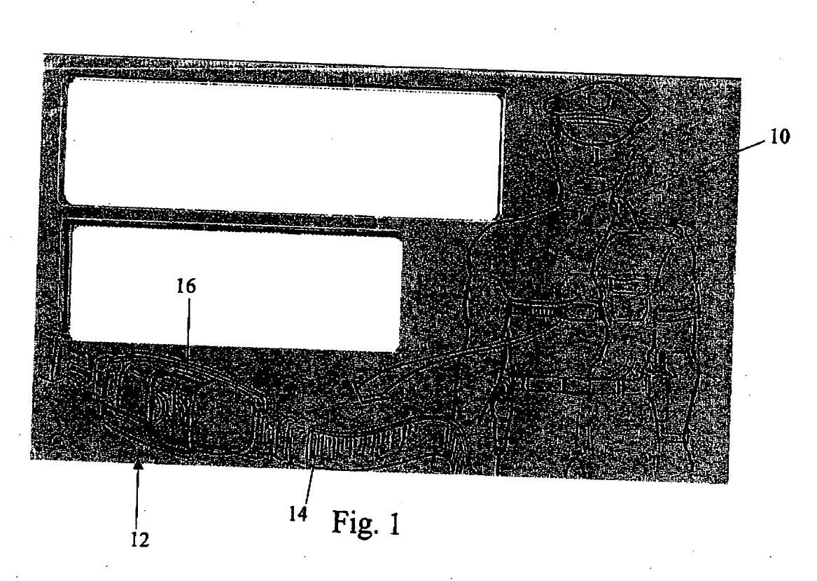

Reference is now made to FIG. 1, which shows an emergency situation detection apparatus placed on a user.

In FIG. 1, a subject 10 has an emergency situation detector 12 attached thereto. The detector comprises a belt 14 and housing module 16. The housing module 16 comprises sensing devices and a transmitter. Preferably the detector 12 is concealed beneath the subject's clothing. The detector 12 is preferably able to send signals in non-contact manner to a nearby repeater, which will be discussed in grater detail below.

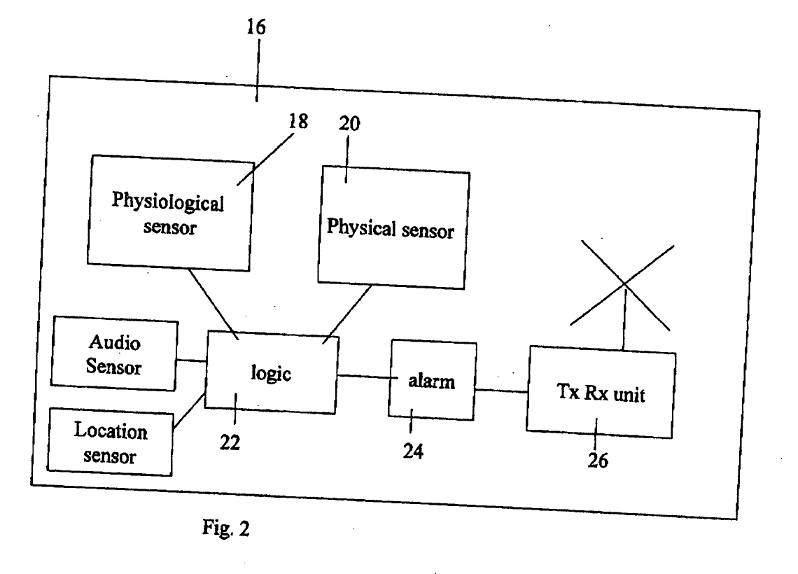

Reference is now made to FIG. 2, which is a simplified block diagram illustrating the interior of housing module 16. The housing module 16 comprises bodily function sensor 18 and physical reaction sensor 20. The bodily function sensor may for example detect pulse rate or sweat levels of the subject. It may also detect ECG or like signals.

The bodily function sensor 18 receives physiological body stress level information. The physical reaction detector 20, for example a 3D accelerometer, or a piezoelectric sensor or any other suitable sensor, preferably detects sudden movements, and/or may provide indications of an impact of some kind or the attainment of a horizontal position or like indicators of physical reaction. Neither physiological stress alone nor physical reaction alone are reliable indicators of an emergency situation but both taken together may be expected to increase the reliability of any determination of an emergency situation. Additional sensors such as an audio sensor, a GPS or other location sensor and the like may be provided as well as spare capacity for adding additional sensors.

Preferably a comparison unit 22 is associated with the bodily function and reaction detectors, for comparing signal information to determine substantially simultaneous occurrence of stress level increase and physical reaction in the subject. The sampling rate may be set to measure the same event at different rates to obtain different information. The detections may be thresholded as deemed sensible by the skilled person to increase reliability of detection. Different thresholds may be appropriate for different kinds of subject. Thus elderly people may be better served by a lower threshold than a security guard. As a further alternative, instead of a fixed threshold level, the system may monitor the change in signal level over time. The change or delta may then be thresholded. Thresholding the deltas can distinguish high signal levels which are due to a rapidly occurring event from high signal levels which may be due to background stress and the like.

The thresholded output of the comparison unit, follow a positive result of the thresholding, is passed to an alarm state manager 24 to imply the presence of a emergency situation and to enter an alarm state. A transmitter 26 responds to the alarm state manager 26 to transmit alarm signals say via Bluetooth, to the nearby repeater. As well as R.F. the transmitter 26 may be able to transmit using sonic ultrasonic, infra-red or like signals.

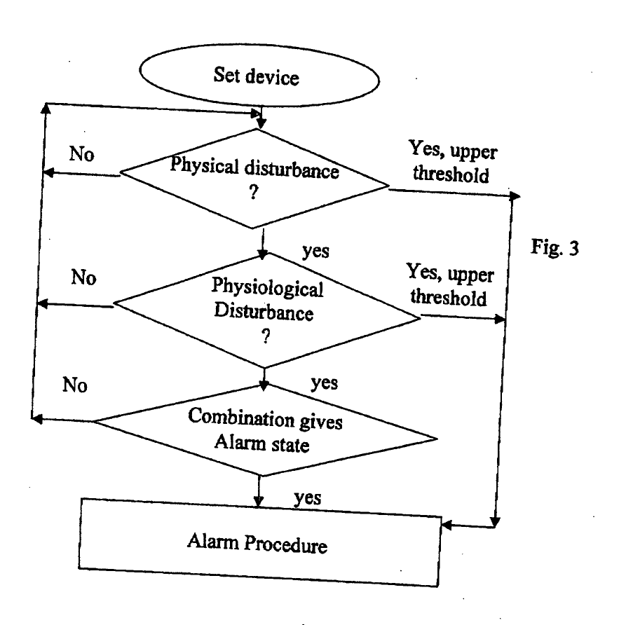

Reference is now made to FIG. 3, which is a simplified flow chart illustrating the process of detecting an emergency. When an individual comes under physical attack or finds himself in a hazardous situation, his body is subjected to changes in two identifiable parameter groups, physiological changes and physical changes. The physiological changes include changes in pulse rate, increased sweating and/or changes in the rate of respiration. Physical changes may include changes in the three dimensional angle of recline, a detectable directional impact, a directional sway, changes in motion, thus step count, etc, directional positioning sensing, unexpected changes in the GPS or other positioning fix, audio signals, and the like. Thus many persons may sway whilst walking, but the sway is measurably different from the sway of someone walking away with a serious injury, and is different again from someone undergoing an impact. Likewise a sequence such as impact, sway, impact, can be detected as a good sign of trouble.

A preferred embodiment of the present invention uses at least a two-layer logic system for describing events and deciding whether to derive an alarm state. In the first level different kinds of events that could indicate trouble are identified. On the second level various combinations of the events in the first level are defined as setting alarm states. The use of the two level system thus reduces the level of computation required in order to arrive at the alarm states.

Examples of the events are as follows: A sudden linear acceleration in any direction, sudden acceleration being defined in any suitable manner, say an acceleration in any direction of greater than 1G for a user not expected to be in a vehicle. The threshold may be altered automatically when the user enters a vehicle to a level suitable for the vehicle. As well as acceleration in general there is also angular acceleration. Thus a guard who rests his head on a table will have an angular acceleration below a certain level, but if the guard is hit from being the angular acceleration is likely to be a lot higher. Likewise the impact as his head hits the table is likely to be recognizable higher. Thus another event that can be identified is the impact event, which can again be thresholded. An event of no movement greater than 0.1G for a period of ten minutes could also be chosen for an event, with the time and acceleration being varied depending on whether the guard is supposed to be on patrol or sitting in a guard house or in a vehicle.

A user falling or leaning forward at a given angle or greater may be one kind of event and the same backwards may be another. Likewise sideways, either left or right can be defined as separate events, and typically different threshold levels would apply to these events.

Thus the system can define certain inclinations and the like as being important if they are for a certain amount of time or in a certain direction. Otherwise they are ignored. Thus the system is able to distinguish between a user being hit from behind over the user merely bending over to tie his shoelaces.

Sound and voice events can be defined as well. For example a sound event such as a gunshot or glass breaking or a scream cam be defined. A voice event such as a cry for help can also be defined. Voiceprint technology can be used to identify the source of the cry and to react only if it belongs to the recognized user. Events with the physiological detector, such as heartrate exceeding a high threshold for a certain amount of time, or being below a minimal threshold for a given amount of time can also be defined. An out of location event can also be defined, meaning the guard is not where he is supposed to be. Likewise if the guard moves between A and B and takes longer than he should, that too could be then as an event. Perhaps he bas met an intruder.

On the second level the individual events are combined in certain ways to achieve alarm states. Thus an out of location event plus a rise in heartrate may trigger an alarm state. Likewise a gunshot plus a drop on heartrate or blood pressure may trigger a high priority alarm state. Certain events taken alone may also trigger alarm states. The reader will appreciate that there are numerous events and numerous combinations of events that can be constructed in order to arrive at alarm states, and the skilled person will know how to customize the alarm states and combinations for different circumstances. Thus a system for soldiers on patrol may be customized in one way. A rape alarm system for women would be customized in another way and an elderly person's safety monitoring system would be customized in yet a third way. A guard who is supposed to be watching a screen in a control center could be monitored for body angle to determine whether he is at an angle at which he could or could not see his screen.

FIG. 3 shows physical disturbance being measured first and then physiological disturbance. It will be appreciated that that the disturbances can be measured in a different order, or if a disturbance in one exceeds a certain threshold or meets a given criterion, then the other need not be measured. Furthermore it is possible to build the system with two separate processors, one for each type of disturbance, so that the two are measured in parallel.

It is also possible to add voice recognition to the system. Thus, words such as “help” or screams can be automatically recognized and used as indicators of emergency situation. Furthermore the system can use voiceprint technology to ascertain that the genuine user is present and not an imposter. The voice information can be used alone, or in conjunction with physiological and/or physical information, for example using logic rules. For the purposes of FIG. 3, voice recognition is simply an additional decision box along with physical and physiological disturbances.

Prevention of false positive or false negative alarms can be achieved by monitoring both the physical & physiological parameter groups, that is data super positioning, by automatic audio monitor for verification, and by using algorithms to reject normal physiological & physical changes or electronic noise. As shown in FIG. 3, the physical and physiological parameters are taken together to decide whether an abnormal situation has occurred. If so an alarm state is set.

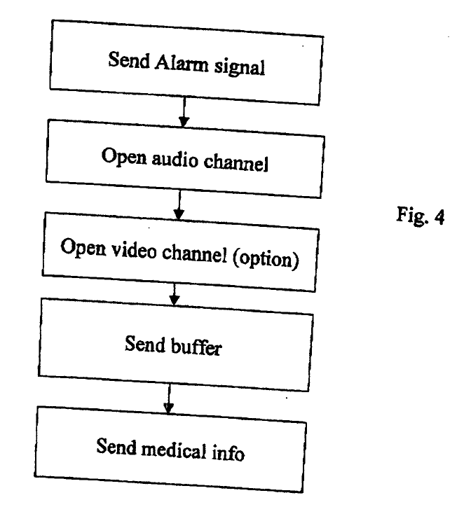

Reference is now made to FIG. 4, which is a simplified diagram illustrating a the continuation of the flow chart after the alarm state has been entered. Preferably the alarm state manager is able to call for assistance, for example via automatic opening of a radio link, or of a video link, to a central controller, thus to provide immediate indication of an emergency state. Preferably, the link, which is at least an audio link, includes at one end a speaker and or microphone located on the body of the user. The link may be a direct link, suitable for short ranges, or where a dedicated line is available. Typically the link may involve a wireless link from the guard to a relay device. Relay devices may be set up at regular intervals in the area being guarded. The relay device may then make use of the PSTN or cellular or any other suitable network to reach the central controller.

In a preferred embodiment the relay device may have additional functions. For example it may have its own sensors that are activated upon detection of an emergency situation at a nearby device. Thus it may be connected to a video camera or a microphone.

Once a real state of emergency is determined by the mounted alert device, the following occurs, preferably entirely automatically, as shown in FIG. 4.

The alarm device sends an Alert Signal, typically, but not necessarily, via RF.

The alarm device sends a GPS fix or other geographical fix via RF to the center, affixing guard's location on say a target area digital map.

The alarm device preferably opens an audio channel preferably again via RF, to the center, enabling a remote listener to evaluate the severity of a situation at fist hand. The alarm device may optionally open a Video channel, via RF or any other available medium, to the center, enabling a remote viewer to evaluate the severity of a situation from a visual point of view. Small video cameras may be mounted with the device on the user, or alteratively may be located on walls and the like in the area being guarded.

The alarm device preferably sends a 60 Second Audio/Data Memory Package to the center. The package contains full data for a predetermined period of time prior to the beginning of the hostile act.

The alarm device preferably sends (post event) the guard's online ECO & respiratory data, enabling real time remote evaluation of a victim's medical condition.

As well as dealing with emergency situations, the device is also able to deal with regular situations, reporting on day to day activities. Thus the personally mounted alarm device preferably constantly records all Data as a memory package. Then, upon request from the center, all audio & data content of the memory package can be downloaded for analysis according to predetermined parameters. It is thus possible to find out such things as whether the guard is or was reporting reliably, whether the guard is or was negligent on a patrol mission, whether the guard is or has been exposing his employer to a potentially hazardous situation, whether a person is in good health, and the like.

In a further preferred embodiment specifically for an aircraft cockpit, the alarm state manager is able to initiate an automatic download of the aircraft's flight recorder or black box data to a central controller, thus making available flight information even if the black box is never recovered. The embodiment may obtain information about the position or height or attitude of the aircraft or any other information regarding aircraft control, from the flight recorder or from sensors provided with the embodiment. In one preferred embodiment, a camera is positioned in the cockpit and simply photographs the control panel, thereby to transmit all of the information available from the control panel as a single image or a series of images.

In a further preferred embodiment, flight information is taken by splicing communication cables in order to monitor passing data.

The alarm state manager is preferably also able to enter an alarm state under the influence of other detectors, for example with detection of a loud noise or following prolonged instability. The alarm state manager may be able to enter different levels of alarm states prompting different actions.

It is often important with air and spacecraft to be aware of the situation on the outer surface of the craft. Therefore, in another preferred embodiment, the system includes cameras with external views as part of the system's sensors. Alternatively the cameras may be externally mounted to provide internal views. Cameras may be mounted in blisters on the aircraft skin, or small cameras may be included into the thickness of the skin. Thus it is possible for the pilot to verify say that the undercarriage is in the correct position or the pilot is able to estimate external damage etc.

As shown in FIG. 4, the emergency situation detector includes an audio or other confirmation channel which can be opened upon detection of an emergency in order to provide confirmation of the situation or allow two-way communication, or the like.

As mentioned above, the emergency situation detector 12 includes a GPS detector to provide positioning information. For use in a building or other places where GPS signals may not be available, a triangulation system may be installed for accurate positional information. As a further alternative, location information may not be provided by the detector 12 but rather by the relay device.

A further preferred embodiment intended for a user who stays within a predefined area such as a security guard on patrol, simply sends regular code signals from which the system infers that he is in position.

Further preferred embodiments are provided to determine attitude, position and motion of a subject. Thus the emergency situation detector may include an accelerometer. A detector for detection of a direction that a user is facing may be strapped to the chest or a like part of the body. The detector includes a compass needle and the relative alignment of the compass needle relative to a predefined forward direction of the body provides information as to the direction the user is facing. At the controller's end the individual user may be represented by a 3D animation which the direction and attitude of the guard.

In a further preferred embodiment, emergency situation detectors are provided to two or more persons in a team. The signals from different members of the team can be compared to determine who is the closest to an event. For example the intensity of an audio signal as received from two different users can be compared to determine who was the closest to an explosion. The team can then be instructed accordingly to deal with the situation.

As an alternative, the physical signal can be compared with a detector of the surroundings, for example a detector located on the wall of the aircraft. Thus vibrations due to the aircraft can be discounted by a simple subtraction operation involving the two sets of signals. It will be appreciated that the use of such a second sensor is applicable to any vehicle or vessel and not just an aircraft.

In one embodiment, data is stored for a predetermined time in a stack, for example a FIFO stack. The size of the stack may be a given amount of data, or may be a given amount of time, or some other factor as preferred. In the event of the detection of an emergency situation, all of the data currently in the stack is saved or immediately transmitted for remote saving, so as to allow subsequent analysis. The stack embodiment is useful because it makes available information from directly before the emergency, often extremely useful in any investigation.

Embodiments of the present invention may use a private communication channel. In one embodiment the equipment located on the user has a short range radio transmitter receiver and a corresponding transmitter receiver is located over a telephone socket, to provide the relay device referred to above. The device at the telephone socket includes an automatic dialer which makes a connection with the controller. For greater range the device at the user may transmit to a repeater which then transmits over a greater range. One embodiment of the repeater may be located at a convenient nearby power socket. Another embodiment may be located on the person. Other embodiments may make use of existing channels such as the cellular network. Yet other embodiments may comprise universal communicators which make use of public networks if detected and use their own channel of communication otherwise.

According to a further embodiment a system comprises rule based logic and one or more body sensors for location on the subject. The subject is expected to follow certain behavioral rules, for example a guard patrols by walking around within a certain area. If he were to run or lie down it would be apparent that an abnormal situation may have arisen. Thus the sensor is usable in combination with the rule based logic to detect non-compliance with the behavioral rules, to indicate an abnormal situation and if necessary to set off an alarm or otherwise summon help. It will be clear that the more independent sensors are used the more reliable the determination can be.

In other circumstances, a guard may be expected to run and lie down to observe suspicious circumstances. In such a case the system may not react under such circumstances, but may await an additional indication such as an impact or the sound of an explosion, or signs or rolling or the like or an indication of an impact prior to the guard lying/falling down and having his physiological ridings change, which may indicate that the guard is under attack.

In a preferred embodiment the detectors are programmable. The rules can be changed for different users or for allowing the same device to be given to different users having different requirements. The device can also be dynamically programmable according to parameters it is able to detect. Thus it may be able to use detected locations to change between different sets of rules. Or as another example a device programmed for use by a fireman may change the rules it is using depending on the temperature it detects. In a further example the change of rules may be carried out on line, for example over a radio connection.

A position or location detector may be used in combination with the above system and the rules preferably define location based behaviors.

At decision marker level the alarm system's primary operational implications is its ability to assist a decision maker to have a clear picture of the situation at a remote location. In emergency mode the decision maker is notified in real-time of any breach of the human line of defense. He obtains a first hand understanding of a hazardous situation in real time. The reaction time to take containment action is considerably reduced as is the likelihood that the correct containment action will be selected, real time monitoring of a guard's performance is possible so that it is clear whether he is coping, needs backup or even medical treatment and the like. Likewise it is possible to monitor in real time the guard's tactical or technical abilities or lack thereof and to spot redundancies. As mentioned above, it is possible to provide continuous monitoring of the guard's medical condition vie EKG & respiratory state evaluation.

Likewise, during day to day operation it is possible to dramatically improve or upgrade the level of guarding services rendered. The system can obligate guards to perform in an optimal way at all times, by providing real time monitoring of the guard's performance. It allows post factum analysis of the guard s performance. It dramatically improves the guard's reliability and dramatically improves the guard's personal safety.

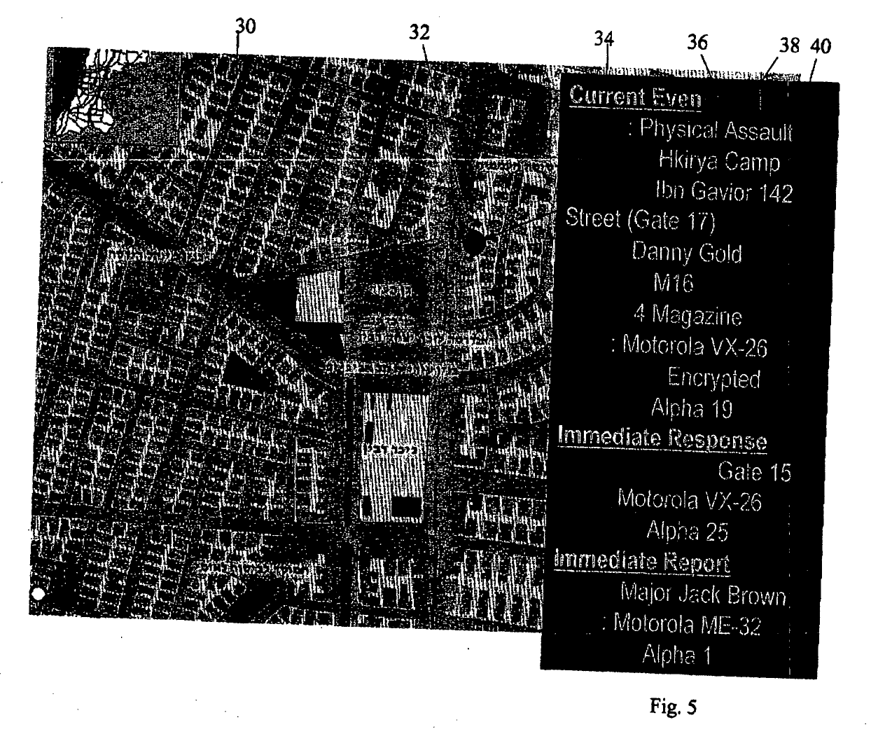

Reference is now made to FIG. 5, which is a simplified diagram illustrating the controller's screen of a preferred embodiment of the present invention. The screen shows digital map 30 of a region. An event occurs and the location of the event is marked on the map by marking 32. A data window 34 displays data of the event such as the identity of the guard, the type of event etc. Three buttons at the top of the data window 34 provide respectively an audio link 36 to the guard, replay of the FIFO stack 38 and an e-mail link 40 to a designated responsible person.

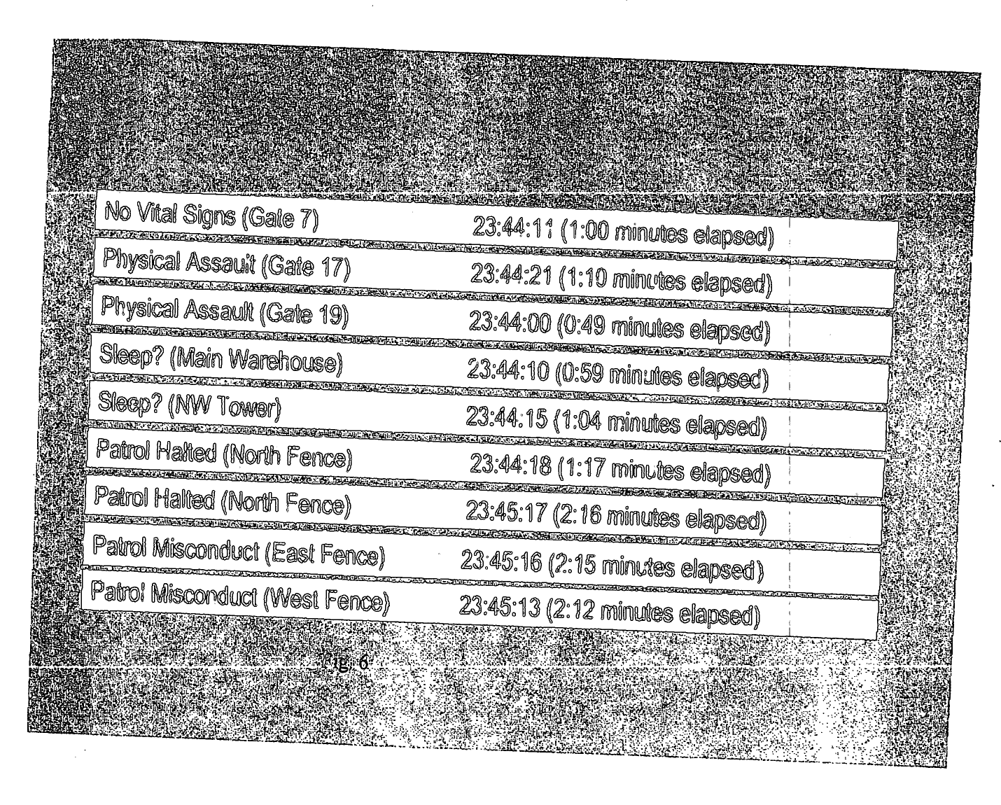

Reference is now made to FIG. 6 which is a screen shot of an event monitoring and management screen. A series of events and timings are shown for different locations or patrols. The different kinds of events are assigned a position in a hierarchy and displayed accordingly. Thus an indication of “no vital signs” is shown as a highest priority event over “physical assault” and others. Secondary sorting is then carried out based on time.

The Alert System is designed to operate in a highly versatile multi task environment and three preferred embodiments are provided for three different environments, an airborne version, a seaborne version and a land version. It is pointed out that the following deals with security versions and not with versions for monitoring elderly or other persons at risk for medical reasons.

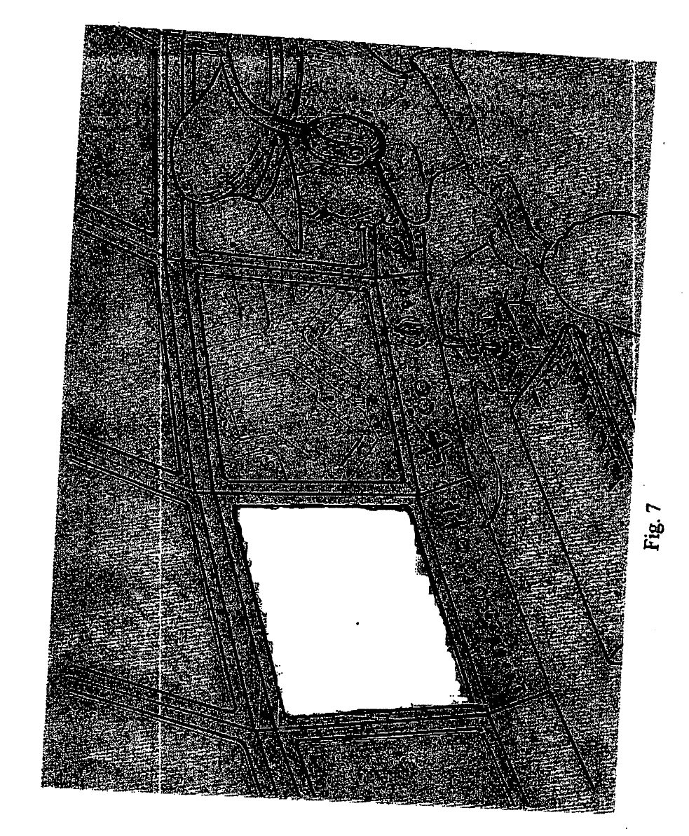

The airborne version, shown in FIG. 7 as being used by an air traffic controller as the central controller, is provided with double redundancy and deals with threat types such as hostile takeover attempts at the aircraft. The product is an alert device+monitoring service with full time remote monitoring and assistance via a control center.

Once a pilot or air marshal assault is detected by the mounted alert device, the following occurs automatically:

Firstly the alert device opens a real time Data channel (aircraft to HQ) via RF which relays GPS data fixing the aircraft location on a target area digital map, preferably an altimeter reading, preferably a 3D electronic gyroscope reading. Preferably a real time Audio channel is opened between the aircraft and the control center enabling a remote listener to evaluate the situation's severity at first hand. Preferably the alert device sends via RF a 60 Second Audio/Video/Data memory package to HQ Fully unveiling on-board events taking place prior to the beginning of the detected hostile act.

In a preferred embodiment, the alert device opens via RF a real time Video channel between the aircraft and the control center, enabling a remote viewer to evaluate the situation's severity visually.

It is noted that an aircraft has expected behavior patterns. Thus a passenger aircraft is not expected to carry out acrobatics, and aircraft are expected to keep to their planned courses. Deviations from the expected behavior, such as a passenger plane overturning, may be taken in whole or in part as indications of an emergency. In such a case the event may be used to trigger downloading of data from the flight recorder or black box or the buffer of the system of the present embodiments. It may also open the audio or video channel and transmit the ongoing event, or readings from the event.

The alert device sends, as post event data, again via RF, the pilot or sky marshal's online EKG & respiratory data enabling real time remote evaluation of a victim's medical condition.

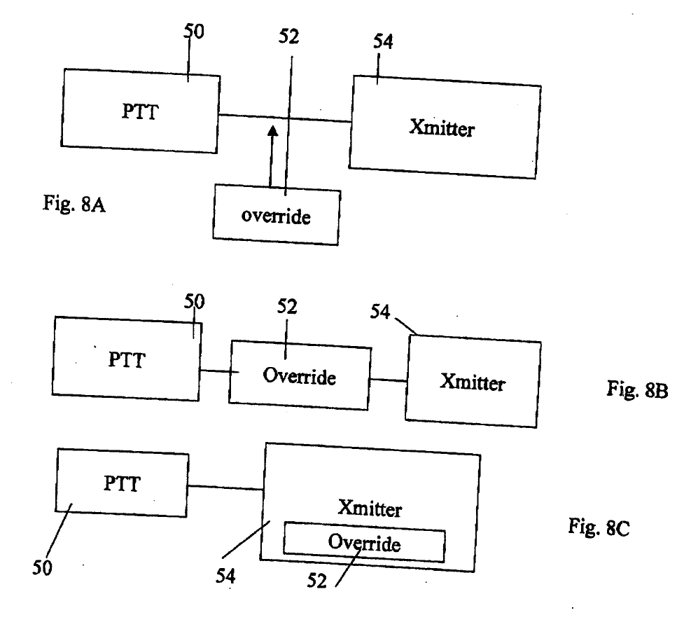

Reference is now made to FIGS. 8A to 8C which show three different configurations for the communication system. In an aircraft, unlike in other environments, safety issues are raised by using additional communication systems. The preferred embodiment therefore makes use of the aircraft PTT communication system 50 via an override device 52 to take control of transmitter 54. In FIG. 8A the override lies outside the direct connection between the PTT and transmitter. In FIG. 8B it directly intercepts the connection and in FIG. 8C the overide device is a part of the transmitter 54.

As a further alternative, a satellite link can be used, as is currently being proposed for mobile telephones on passenger aircraft.

A seaborne version is similar and has double redundancy. It is intended for threat types such as hostile takeover, piracy and the like. The product is once again an alert device+monitoring service, with full time monitoring and remote assistance via a control center.

Once a bridge crew assault is detected by the mounted alert device, the following occurs automatically. First of all the alert device opens a real time Data channel between the Ship and the center, relaying GPS data fixing the ship's location on a target area digital map. Additionally, the alert device opens via RF a real time audio channel between the ship and the center, enabling a remote listener to evaluate the situation's severity at first hand. The alert device also preferably opens, via RF, a real time video channel between the ship and the center, enabling a remote viewer to evaluate the situation's severity at first hand.

The alert device sends via RF a 60-90 Second Audio/Video/Data memory package to HQ Fully revealing bridge crew evens taking place prior to the beginning of the hostile act.

The alert device preferably also sends, post event, the bridge crew online EKG & respiratory data enabling real time remote evaluation of the victim s medical condition.

Ships generally have expected behaviors and courses. Deviations from the course can be taken as suspicious events. The system can be hidden on the ship.

A land based version is for threat types such as hostile intrusion or takeover of a secured area/facility, as well as for monitoring of personnel on dangerous missions, say soldiers, police or firemen. Landbased vehicles include both road vehicles, off-road vehicles and railway vehicles.

There are two versions of the land based product, one for static or foot based users, and one for mobile or mechanized users. Again the product is an alert device with a full time remote monitoring service.

Once a guard assault is detected by the mounted alert device, the following occurs automatically. First of all the alert device sends an Alert Signal, preferably via RF. The device sends GPS co-ordinates fixing the guard's location on a target area digital map. The alert device opens via RF an audio channel to the center enabling a remote listener to evaluate situation's severity at first hand, and if possible talk to the guard. The alert device preferably sends via RF a 60 Second Audio/Data Memory Package to HQ Fully unveiling events taking place prior to the beginning of the hostile act. In addition the alert device sends, following the event, again typically via RF, the Guard's online EKG & respiratory data enabling real time remote evaluation of victim's medical condition.

Optionally, if video cameras are present in the vicinity, the alert device opens a video channel via available infrastructure to the center.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described herinabove. Rather the scope of the present invention is defined by the appended claims and includes both combinations and subcombinations of the various features described here inabove as well as variations and modifications thereof which would occur to persons skilled in the art upon reading the foregoing description.

1. Emergency situation detection apparatus comprising:
a stress input unit for receiving body stress information from a subject,
a physical input unit for receiving body physical reaction data from said subject,
a comparator unit, associated with said stress input unit and said physical input unit, for comparing stress level information and physical reaction data, to detect substantially simultaneous stress level change and a physical reaction in said subject,
said apparatus being operable to threshold said simultaneous detection to infer the presence of an emergency situation and to enter alarm state.

2. Emergency situation detection apparatus according to claim 1, wherein said thresholding is a thresholding of said changes.

3. Emergency situation detection apparatus according to claim 1, configured for attachment to said subject.

4. Emergency situation detection apparatus according to claim 1, configured for attachment to the trunk region of a user, above the hip region.

5. Emergency situation detection apparatus according to claim 4, configured for attachment to the chest.

6. Emergency situation detection apparatus according to claim 4, configured for attachment around the stomach.

7. Emergency situation detection apparatus according to claim 1, configured for attachment on the hips.

8. Emergency situation detection apparatus according to claim 1, wherein said stress level information comprises pulse rate information.

9. Emergency situation detection apparatus according to claim 1, wherein said stress level information comprises breathing rate information.

10. Emergency situation detection apparatus according to claim 1 wherein said stress level information is sweat level information.

11. Emergency situation detection apparatus according to claim 1, further comprising a sensor for detecting ECO information.

12. Emergency situation detection apparatus according to claim 1, configured to interpret extremely low stress level information as said subject being in a state of sleep.

13. Emergency situation detection apparatus according to claim 1, wherein said physical input unit comprises an inclination detector affixed to said subject.

14. Emergency situation detection apparatus according to claim 1, wherein said physical input unit comprises an accelerometer.

15. The emergency situation detector of claim 14, wherein said physical input unit is connected to detection logic to identify physical behavior patters.

16. The emergency situation detector of claim 15, wherein said patterns comprise complexes of impact and sway behavior events.

17. Emergency situation detection apparatus according to claim 1, wherein said input unit is responsive to transmitter its placed on said subject.

18. Emergency situation detection apparatus according to claim 1, wherein said alarm state comprises automatic opening of a communication channel to a central controller.

19. Emergency situation detector according to claim 18, configured to use said communication channel for ongoing transmission during the course of an identified emergency situation.

20. Emergency situation detection apparatus according to claim 1, wherein said alarm state comprises automatic opening of an audio channel to a central controller.

21. Emergency situation detection apparatus according to claim 20, wherein an end of said audio channel is locate said subject.

22. Emergency situation detection apparatus according to claim 1, wherein said alarm state comprises automatic opening of a video link to a central controller.

23. Emergency situation detection apparatus according to claim 1, said alarm state being additionally triggerable by at least one of an instability monitor, and a loud sound monitor.

24. Emergency situation detection apparatus according to claim 1, sized and configured for mounting unobtrusively on a subject.

25. Emergency situation detection apparatus according to claim 1, further comprising location detection functionality for determining a location, said apparatus further being configured to report said location.

26. Emergency situation detection apparatus according to claim 25, wherein said location detection functionality is one of a group comprising a GPS detector and a triangulation system.

27. Emergency situation detector according to claim 1, further comprising a direction sensor, said direction sensor comprising a compass needle and functionality for measuring an angle of said compass needle in relation to a reference.

28. Emergency situation detector according to claim 1, associated with a memory stack for storing a predetermined amount of immediately preceding data, said detector being configured to save all data in said stack upon entry into said alarm state.

29. Emergency situation detector according to claim 1, further comprising a short range communicator for communicating with a relay device.

30. Emergency situation detector according to claim 29, wherein said relay device is connected to a telephone socket.

31. Emergency situation detector according to claim 29, comprising a first relay associated with a user and a second relay associated with a telephone socket.

32. Emergency situation detector according to claim 29, wherein said relay device is a cellular relay device.

33. Emergency situation detector according to claim 29, comprising a first relay associated with a user and a second relay being a cellular relay device.

34. Emergency situation detector according to claim 29, wherein said relay device is a satellite telephony device.

35. Emergency situation detector according to claim 29, comprising a first relay associated with a user and a second relay being a satellite telephony device.

36. Emergency situation detector according to claim 29, wherein said relay device is an r.f. relay.

37. Emergency situation detector according to claim 29, comprising a first relay associated with a user and a second relay being an R.F. relay.

38. Emergency situation detector according to claim 29, wherein said short range communicator is configured to use a wireless local work protocol.

39. Emergency situation detector according to claim 1, adapted for use in a vehicle by fixing a second physical detector to said vehicle and obtaining a difference signal between said physical detectors for feeding to said comparator.

40. Emergency situation detector according to claim 39, wherein said vehicle is any one of a group comprising a land vehicle, a road vehicle, an off-road vehicle, a railway vehicle, a ship and an aircraft.

41. Emergency situation detector according to claim 39, further being adapted for use in said vehicle by including a relay attached to said vehicle to relay signals from said user via said vehicle to said remote location.

42. Emergency situation detection method comprising:
receiving body stress level information from a subject,
receiving body physical reaction data from said subject,
comparing stress level information and physical reaction data, to detect substantially simultaneous stress level change and physical reaction in said subject, and
thresholding said simultaneous detection to infer the presence of an emergency situation and to enter an alarm state.

43. The method of claim 42, wherein said thresholding comprises thresholding of rates of change.

44. The method of claim 42, wherein said stress level information comprises pulse rate information.

45. The method of claim 42, wherein said stress level information is breathing rate information.

46. The method of claim 42 wherein said stress level information is sweat level information.

47. The method of claim 42 wherein said physical reaction data is body angular inclination data.

48. The method of claim 42, wherein said physical reaction data is body acceleration data.

49. The method of claim 42, comprising being responsive to transmitter units placed on said subject.

50. The method of claim 42, wherein said alarm state comprises automatic opening of a radio link to a central controller.

51. The method of claim 42, wherein said alarm state comprises automatic opening of a video link to a central controller.

52. The method of claim 42, further comprising carrying out short range communication for communicating to a central controller via a relay device.

53. A system comprising rule based logic and at least one body sensor for location on a subject, the subject being expected to follow certain behavioral rules, said at least one sensor being usable in combination with said rule based logic to detect noncompliance with said behavioral rules, thereby to indicate an abnormal situation.

54. The system of claim 53, wherein said logic unit is configured to provide two level logic, a first level defining a plurality of events for giving rise to an alarm state, and a second level defining at least one combination of the events in said first level to provide at least one alarm state.

55. The system of claim 54, wherein said events comprise at least one of a group comprising:
a change in linear acceleration of at least a predetermined level within a predetermined time;
a change in angular acceleration of at least a predetermined level within a predetermined time,
an impact of greater than a threshold level;
an acoustic sound of a predetermined spectrum,
a voiced sound of a predetermined set with a predetermined voiceprint;
a body attitude of a predetermined angle or greater held for a predetermined amount of time;
a left body attitude of a predetermined angle or greater held for a predetermined amount of time and a right body attitude of a predetermined angle or greater held for a predetermined amount of time and a forward body attitude of a predetermined angle or greater held for a predetermined amount of time and a backward body attitude of a predetermined angle or greater held for a predetermined amount of time;
a user being outside of a given area for a predetermined amount of time;
a user being or not being at a given location at a predetermined time;
a heartrate outside predetermined bounds for a predetermined amount of time;
sway of predetermined pattern; and
a use taking longer than a predetermined time to reach a given location.

56. The system of claim 54, configured to measure a predetermined event using at least two sampling rates in order to obtain different kinds of information therefrom.

57. The system of claim 53, further comprising at least a second body sensor usable in combination with said behavioral rules.

58. The system of claim 51, wherein said behavioral rules include expected behaviors of a vehicle.

59. The system of clam 53, wherein said events include said user sleeping or dozing when he is not expected to.

60. The system of claim 53, wherein said events include said user walking when expected to be stationary or being stationary when expected to be walking.

61. The system of claim 53, wherein said behavioral rules define expected attitudes of user body positions.

62. The system of claim 53, wherein said behavioral rules define places whereon said user is expected to be located and where said user is expected not to be located.

63. The system of claim 53, wherein said behavioral rules include expected behaviors following major impacts.

64. The system of claim 53, wherein said behaviors include behavior complexes comprising combinations of behavior events.

65. The system of claim 64, configured to rank said behavior in an order of severity.

66. The system of claim 53, further comprising a location detection device and wherein said rule based logic contains rules based on location.

67. The system of claim 53, being programmable to allow disc changing of said rules.

68. A direction sensor for mounting on a mobile body, said direction sensor comprising a compass needle and functionality for measuring an angle of said compass needle in relation to a reference, said direction sensor being configured for mounting in orientation fixed manner on said mobile body.

69. The direction sensor of claim 68, wherein said mobile body is a person, said direction sensor being configured for mount on a part of said person indicative of a direction that said person is fix.

70. Emergency situation detection apparatus comprising:
a physiological input unit for receiving body physiological information from a subject,
a physical input unit for receiving body physical reaction data from said subject, and
a logic unit, associated with said physiological input unit and said physical input unit, for applying at least one logical operation simultaneously to said physiological information and said physical information, to infer the presence of an emergency situation and to enter an alarm state.

71. The Emergency situation detection apparatus according to claim 70, wherein said logic unit is configured to provide two level logic, a first level defining a plurality of events for giving rise to an alarm state, and a second level defining at least one combination of the events in said first level to provide at least one alarm state.

72. Emergency situation detection apparatus according to claim 70, configured for attachment to said subject.

73. Emergency situation detection apparatus according to claim 72, configured for attachment to the trunk region of a user, above the hip region.

74. Emergency situation detection apparatus according to claim 70, wherein said physiological level information comprises pulse rate information.

75. Emergency situation detection apparatus according to claim 70, wherein said physiological level information comprises breathing rate information.

76. Emergency situation detection apparatus according to claim 70 wherein said physiological level information is sweat level information.

77. Emergency situation detector according to claim 70, wherein said physiological information is data indicating whether a user is asleep.

78. Emergency situation detection apparatus according to clam 70, wherein said physical input unit comprises an inclination detector affixed to said subject.

79. Emergency situation detection apparatus according to claim 70, wherein said physical input unit comprises an accelerometer.

80. Emergency situation detection apparatus according to claim 70, wherein said input unit is responsive to transmitter units placed on said subjects.

81. Emergency situation detection apparatus according to claim 70, wherein said alarm state comprises automatic opening of a communication channel to a central controller.

82. Emergency situation detection apparatus according to claim 70, wherein said alarm state comprises automatic opening of an audio channel to a central controller.

83. Emergency situation detection apparats according to claim 82, wherein an end of said audio channel is located on said subject.

84. Emergency situation detection apparatus according to claim 70, wherein said alarm state comprises automatic opening of a video link to a central controller.

85. Emergency situation detection apparatus according to claim 70, said alarm state being additionally triggerable by at least one of an instability monitor, and a loud sound monitor.

86. Emergency situation detection apparatus according to claim 70, sized and configured for mounting unobtrusively on a subject.

87. Emergency situation detection apparatus according to claim 70, further comprising location detection functionality for determining a location, said apparatus further being configured to report said location.

88. Emergency situation detection apparatus according to claim 87, wherein said location detection functionality is one of a group comprising a GPS detector and a triangulation system.

89. Emergency situation detector according to claim 70, further comprising a direction sensor, said direction sensor comprising a compass needle and functionality for measuring an angle of said compass needle in relation to a reference.

90. Emergency situation detector according to claim 70, associated with a memory stack for storing a predetermined amount of immediately preceding data, said detector being configured to save all data in said stack upon entry into said alarm state.

91. Emergency situation detector according to claim 1 wherein said indication of an alarm state comprises any of an impact, an impact causing subject to falling down, and an impact causing physiological readings to change.

92. Emergency situation detector according to claim 42 wherein said indication of an alarm state comprises any of an impact, an impact causing a subject to falling down, and an impact causing physiological readings to change.

93. Emergency situation detector according to claim 53 wherein said indication of an alarm state comprises any of an impact, an impact causing a subject to falling down, and an impact causing physiological readings to change.

94. Emergency situation detector according to claim 70 wherein said indication of an alarm state comprises any of an impact, an impact causing a subject to falling down, and an impact causing physiological readings to change.

95. Emergency situation detector according to claim 94, wherein an additional detector is located on a wall of a vehicle carrying a subject, so as to cancel out vibrations of said vehicle.

96. Central co-ordination unit for controlling a plurality of remotely located emergency situation detectors, each detector comprising:
a stress input unit for receiving body stress information from a subject,
a physical input unit for receiving body physical reaction data from said subject,
a comparator unit, associated with said stress input unit and said physical input unit, for comparing stress level information and physical reaction data, to detect substantially simultaneous stress level change and a physical reaction in said subject
said apparatus being operable to threshold said simultaneous detection to infer the presence of an emergency situation and to enter an alarm state,
said co-ordination unit comprising an alarm unit for indicating that one of said detectors has entered an alarm state and a contact unit for contacting and providing a location of said one of said detectors having entered said alarm state.

97. Vehicle protection unit for emergency situation detection and monitoring of said vehicle, said protection unit comprising:
a sensor associated with said vehicle for sensing vehicle situation data;
a logical unit associated with said sensor for determining from the output of said sensor whether an emergency situation is present; and
an alarm unit for entering an alarm state on detection of said emergency situation, said alarm state comprising setting a transmitter to transmit vehicle situation data to a remote location.

98. The vehicle protection unit of claim 97, wherein said sensor is an inclination sensor for detecting inclination information of said vehicle.

99. The vehicle protection unit of claim 98, wherein said inclination unit is a multi-dimension inclination unit.

100. The vehicle protection unit of claim 97, wherein said logical unit comprises an expected behavior pattern for said vehicle and is configured to recognize deviations from said expected behavior patterns as indicative of said emergency situation.

101. The vehicle protection unit of claim 97, wherein said sensor comprises an impact sensor for sensing an impact associated with said vehicle.

102. The vehicle protection unit of claim 97, wherein said sensor comprises an audio detector for detecting audio disturbances in association with said vehicle.

103. The vehicle protection unit of claim 97, wherein said sensor comprises a fume detector for detecting fumes in association with said vehicle.

104. The vehicle protection unit of claim 97, wherein said sensor comprises a radiation detector for detecting radiation presence in association with said vehicle.

105. The vehicle protection unit of claim 97, wherein said sensor comprises an accelerometer for detection acceleration of said vehicle.

106. The vehicle protection unit of claim 97, wherein said vehicle situation data comprises flight recorder data.

107. The vehicle protection unit of claim 97, further comprising a data buffer for storing previous data for a predetermined amount of time and wherein said vehicle situation data is data currently stored in said buffer.

108. The vehicle protection unit of claim 97, wherein said transmitter is configured to transmit vehicle situation data throughout said emergency situation.

109. The vehicle protection unit of claim 97, wherein said transmitter is configured during said emergency situation to open at least one of an audio and a video channel to allow a remote controller to be in contact with said vehicle.

110. The vehicle protection unit of claim 97, wherein said vehicle is at least one of a group comprising an aircraft, a waterborne vessel, a land vehicle, a road vehicle, an off-road vehicle and a railway train.

111. The vehicle protection unit of claim 97, wherein said logical unit is configured to rank different kinds of emergency situations.

112. The vehicle protection unit of claim 97, further comprising a relatively short range communicator for communicating with a relay device.

113. The vehicle protection unit of claim 97, further comprising a relay for relaying signals from persons on said vehicle to a central controller.

114. The vehicle protection unit of claim 97, wherein the vehicle is an aircraft or spacecraft, the unit comprising a camera mounted for viewing a flight control panel, thereby to provide flight data as an image.

115. The vehicle protection unit of claim 114, further comprising a connection for obtaining flight data from a data cable of said craft.

116. The vehicle protection unit of claim 114, further comprising a control connection for initiating data download from a flight recorder of said aircraft.

117. The vehicle protection unit of claim 116, wherein said control connection is configured to carry out said initiating following an indication of an alarm state at said aircraft.

118. The vehicle protection unit of claim 114, configured to carry out continuous download of data to a remote location following said indication of said alarm state.

119. A system comprising rule based logic and at least one body sensor for location on a subject, the subject being expected to follow certain physical rules, said at least one sensor being usable in combination with said rule based logic to detect non-compliance with said physical rules, thereby to indicate an abnormal situation.

120. The system of claim 119, comprising an event pattern comprising a complex of physical events, said event pattern indicating said abnormal situation.

121. The system of claim 120, wherein said complex comprises a first event being an impact event.

122. The system of claim 121, wherein said impact is accompanied by a change of inclination angle.

123. Emergency situation detection apparatus comprising at least one of:
a) a stress input unit for receiving body stress information from a subject,
b) a physical input unit for receiving body physical reaction data from said subject, and
c) a voice input unit for recognizing stress-indicating audio input;
a comparator unit, associated with said at least two input units, for comparing stress level information and physical reaction data, to detect substantially simultaneous stress level change and a physical reaction in said subject,
said apparatus being operable to threshold said simultaneous detection to infer the presence of an emergency situation and to enter an alarm state.

124. The emergency situation detection apparatus of claim 123, comprising at least two of said input units.

125. The emergency situation detection apparatus of claim 123, comprising a short range transmitter for transmitting to a relay device.

126. The emergency situation detection apparatus of claim 123, comprising a transmitter for transmitting to a central controller.

127. The emergency situation detection apparatus of claim 123, configured for attachment to a person.

128. The emergency situation detection apparatus of claim 123, further comprising a location detector being one of a group comprising a triangulation device and a GPS device.

129. Emergency situation detection apparatus comprising
a voice input unit for recognizing stress-indicating audio input;
a comparator unit, associated with said at least two input units, for comparing stress level information and physical reaction data, to detect substantially simultaneous stress level change and a physical reaction in said subject,
said apparatus being fixable to a location and operable to threshold said simultaneous detection to infer the presence of an emergency situation and to enter an alarm state.

130. A relay device for an emergency situation detection apparatus, the relay device comprising a receiver for receiving alarm state data from an emergency situation detection apparatus within range, a data enhancer for enhancing said alarm state data and an output for sending said enhanced data onwards to a remote location.

131. The relay device of claim 130, wherein said data enhancer is configured to add location data of said relay device to said alarm state data.

132. The relay device of claim 130, a said data output is configured for attachment to a telephone socket to work through the PSTN network.

133. The relay device of claim 130, wherein said data output comprises a cellular unit to send data via a cellular telephony network.

134. The relay device of claim 131, configured for mounting on a vehicle, vessel or aircraft, wherein said location data is obtained from a location sensor.

135. A craft for air or space flight, comprising a control system and at least one externally mounted camera connected to said control system and mounted to provide information about a current flight condition of said craft.

136. The craft of claim 135, configured to provide said information to a pilot of said craft.

137. The craft of claim 135, comprising an outer skin and wherein said externally mounted camera is mounted within said skin.

138. The craft of claim 135, wherein said camera is configured to provide a view of an external part of said aircraft.

139. The craft of claim 137, wherein said externally mounted camera is located within a blister of said skin.

140. The craft of claim 135, further comprising an internally mounted camera located for viewing safety-critical areas of said craft.

141. The craft of claim 135, further comprising a transmitter for allowing remote viewing of data from said camera.

142. The craft of claim 135, further comprising a camera mounted for viewing a flight control panel, thereby to provide flight data as an image.

143. The craft of claim 135, further comprising a connection for obtaining flight data from a data cable of said craft.

144. The craft of claim 135, further comprising a control connection for initiating data download from a flight recorder of said aircraft.

145. The craft of claim 144, wherein said control connection is configured to carry out said initiating following an indication of an alarm state at said aircraft.

146. The craft of 140, configured to carry out continuous download of data to a remote location following said indication of said alarm state.
